(19) United States
(12) Patent Application Publication
(10) Pub. No.: US 2014/0064865 A1
(43) Pub. Date: Mar. 6, 2014

(54) APPARATUS AND METHODS FOR MOUNTING A BINDING TO A SKI

(71) Applicant: David Twining, Strawberry, CA (US)

(72) Inventor: David Twining, Strawberry, CA (US)

(21) Appl. No.: 14/012,565

(22) Filed: Aug. 28, 2013

Related U.S. Application Data
(60) Provisional application No. 61/696,101, filed on Aug. 31, 2012.

(51) Int. Cl. B23B 47/28

(52) U.S. Cl. CPC B23B 47/285
USPC 408/1 R; 408/115 R; 408/103

(57) ABSTRACT

An apparatus includes a frame, a centering mechanism, a positioning mechanism, and a mounting plate. The centering mechanism is coupled to the frame and is configured to adjustably center the apparatus widthwise on the ski. The positioning mechanism is coupled to the frame and the mounting plate can be removably coupled to the positioning mechanism. The mounting plate includes a unique pattern of apertures that provide a guide for drilling mounting holes in the ski. The positioning mechanism is configured to adjustably move the mounting plate in a lengthwise direction relative to the ski to a position to accommodate a select length of a select reference member. In some embodiments, a second mounting plate can be removably coupled to the positioning mechanism that can include a second pattern of apertures, which collectively with the pattern of apertures of the mounting plate provide a guide for drilling holes in the ski.

### CROSS-REFERENCE TO RELATED APPLICATIONS

This application claims priority to and the benefit of U.S. Provisional Patent Application No. 61/696,101, entitled “Universal Ski Mounting Jig,” filed Aug. 31, 2012, the disclosure of which is incorporated herein by reference in its entirety.

### BACKGROUND

Embodiments described herein relate generally to a jig that can be used to facilitate the mounting of ski bindings to a ski and, more particularly, to apparatus and methods for a universal jig that can accommodate multiple ski, binding, and boot configurations to facilitate the placement and mounting of bindings to a ski.

The current design of skis (e.g., snow skis) varies greatly depending on the style of skiing for which the ski is designed. For example, a ski designed for “all-mountain skiing” can vary in shape and size from a ski designed for “race skiing.” In some instances, the width of a ski (e.g., at the ski waist or relative center of the ski) can double from a width of a relatively narrow ski to the width of a relatively wide ski. Moreover, the desired placement of a ski boot relative to the ski (e.g., along a length of the ski) can also be largely variant. For example, in considering a ski configured for terrain park skiing, it can be desirable for the placement of a ski boot relative to the ski to be forward of the center of the ski while for a ski configured for all-mountain skiing it can be desirable for the placement of the ski boot relative to the ski to be substantially at the center of the ski.

Ski bindings are typically mounted to a ski using a jig or other like fixture or device to define where the mounting holes are to be located. Ski bindings can be mounted to a ski by an individual owner, for example, after purchasing skis, and/or by businesses, such as ski shops that sell skis and/or bindings, and/or by ski or binding manufacturers. In any case, there may be limited availability of the hardware and/or mounting jigs. For example, a jig that is suitable for facilitating the mounting of bindings from a given manufactured may not be suitable for facilitating the mounting of bindings from a different manufacturer. As such, the individual and/or business may need to purchase multiple jigs associated with specific binding manufacturers which can be expensive as well as challenging to store. Furthermore, as the design of a binding from a given manufacturer changes (e.g., the hole pattern changes), a jig that was once suitable may no longer be suitable for the newly designed binding. In addition, a particular jig may be unable to accommodate a particular ski, binding, and/or boot configuration. For example, a ski can be too wide for a jig or the ski boot can be too big.

Thus a need exists for improved apparatus and methods for mounting a binding to a ski and in particular for a mounting jig that can be used facilitate the mounting of different types, styles and/or sizes etc. of ski bindings having varying hole patterns for mounting to a ski.

### SUMMARY

Apparatus and methods for a universal jig that can facilitate the placement and mounting of bindings to a ski are described herein. In some embodiments, an apparatus includes a frame, a centering mechanism, a positioning mechanism, and a mounting plate. The centering mechanism is coupled to the frame and is configured to adjustably center the apparatus widthwise on the ski. The positioning mechanism is coupled to the frame and the mounting plate can be removably coupled to the positioning mechanism. The mounting plate includes a unique pattern of apertures that provide a guide for drilling mounting holes in the ski. The positioning mechanism is configured to adjustably move the mounting plate in a lengthwise direction relative to the ski to a position to accommodate a select length of a select reference member.

### BRIEF DESCRIPTION OF THE DRAWINGS

FIG. 1 is a schematic illustration of a jig according to an embodiment.

FIG. 2 is a top view of a jig coupled to a ski according to an embodiment.

FIG. 3 is a partial exploded perspective view of the jig of FIG. 2.

FIG. 4 is a perspective view of a portion of the jig of FIG. 2 coupled to the ski of FIG. 2.

FIG. 5 is an enlarged perspective view of a portion of the jig of FIG. 4 identified by the region X₁ in FIG. 4, shown in a first configuration.

FIG. 6 is a perspective view of a clamp member included in a centering mechanism of the jig of FIG. 2.

FIG. 7 is a perspective view of an actuator included in the centering mechanism of the jig of FIG. 2.

FIG. 8 is an enlarged perspective view of the portion of the jig of FIG. 4 identified by the region X₁ in FIG. 4, shown in a second configuration.

FIG. 9 is a top view of a portion of the jig of FIG. 2 coupled to a ski.

FIG. 10 partial exploded perspective view of the jig of FIG. 2.

FIG. 11 is a cross-sectional view of the jig of FIG. 2 taken along the line 11-11 in FIG. 2.

FIG. 12 is an enlarged view of a portion of the jig of FIG. 11 identified by the region X₂ in FIG. 11.

FIG. 13 is a perspective view of the jig of FIG. 2 coupled to the ski and a schematic illustration of a ski boot coupled to the jig.

FIG. 14 is an enlarged view of a portion of the jig and the schematic illustration of the ski boot of FIG. 13 identified by the region X₃ in FIG. 13.

FIG. 15 is a perspective view of the jig of FIG. 2 coupled to the ski and schematic illustration of a ski boot, shown in another configuration.

FIG. 16 is an enlarged view of a portion of the jig and the ski boot of FIG. 15 identified by the region X₄ in FIG. 15.

FIG. 17 is a perspective view of a first mounting plate and a second mounting plate, according to an embodiment.

FIG. 18 is a perspective view of a first mounting plate and a second mounting plate, according to another embodiment.

FIG. 19 is a perspective view of a mounting plate, according to another embodiment.

FIG. 20 is a flowchart illustrating a method of using a universal jig according to an embodiment.

### DETAILED DESCRIPTION

Apparatus and methods for a universal jig that can facilitate the placement and mounting of bindings to, for example, a snow ski are described herein. The universal can be used with multiple different configurations of removable mounting plates that define a unique pattern of apertures associated with a particular binding. The mounting plates can be removably coupled to the jig and used to guide a user where to drill holes in the ski to mount the binding. The jig can then be removed and the binding can be coupled to the ski. The use of a single jig having removable mounting plates to accommodate various types and configurations of bindings can reduce the costs associated with maintaining multiple jigs to accommodate multiple different types of bindings. The universal jig can also be beneficial when, for example, a particular ski binding has a modification (e.g., by a manufacturer). Rather than having to purchase a new jig to accommodate the new binding, a user can acquire mounting plates that have the unique pattern of apertures corresponding to the new binding. The universal jig can also be used for positioning, for example, demonstration bindings such as those used as ski shops.

In some embodiments described herein, an apparatus (e.g., jig) includes a frame, a centering mechanism, a positioning mechanism, and a mounting plate. The centering mechanism is coupled to the frame and is configured to adjustably center the apparatus widthwise on the ski. The positioning mechanism is coupled to the frame and the mounting plate can be removably coupled to the positioning mechanism. The mounting plate includes a unique pattern of apertures that provide a guide for drilling mounting holes in the ski. The positioning mechanism is configured to adjustably move the mounting plate in a lengthwise direction relative to the ski to a position to accommodate a select length of a select reference member.

In some embodiments, a mounting plate is configured to be selectively coupled to a mounting jig for use in drilling a set of holes in a ski to be used to mount a ski binding to the ski. The mounting plate defines a select pattern of apertures associated with a select ski binding. The apertures are configured to be used to guide the drilling of a set of holes in a ski.

In some embodiments, a method includes positioning a mounting jig on a ski. A centering mechanism is actuated to adjustably center the mounting jig widthwise on the ski. A mounting plate can be coupled to a positioning mechanism of the mounting jig. The mounting plate defines a pattern of apertures to be used to drill holes in the ski. A reference member is positioned on the mounting jig. The positioning mechanism is actuated such that the mounting plate is adjustably moved to a select position to accommodate a length of the reference member. The method includes drilling holes in the ski at the location of the pattern of apertures.

As used in this specification, the singular forms “a,” “an” and “the” include plural referents unless the context clearly dictates otherwise. Thus, for example, the term “a member” is intended to mean a single member or a combination of members, “a material” is intended to mean one or more materials, or a combination thereof.

As used herein, the term “set” can refer to multiple features or a singular feature with multiple parts. For example, when referring to a set of walls, the set of walls can be considered as one wall with multiple portions, or the set of walls can be considered as multiple, distinct walls. Thus, a monolithically constructed item can include a set of walls. Such a set of walls may include multiple portions that are either continuous or discontinuous from each other. A set of walls can also be fabricated from multiple items that are produced separately and are later joined together (e.g., via a weld, an adhesive, or any suitable method).

As used herein, the term “parallel” generally describes a relationship between two geometric constructions (e.g., two lines, two planes, a line and a plane or the like) in which the two geometric constructions are substantially non-intersecting as they extend substantially to infinity. For example, as used herein, a line is said to be parallel to another line when the lines do not intersect as they extend to infinity. Similarly, when a planar surface (i.e., a two-dimensional surface) is said to be parallel to a line, every point along the line is spaced apart from the nearest portion of the surface by a substantially equal distance. Two geometric constructions are described herein as being “parallel” or “substantially parallel” to each other when they are nominally parallel to each other, such as for example, when they are parallel to each other within a tolerance. Such tolerances can include, for example, manufacturing tolerances, measurement tolerances or the like.

As used herein, the terms “perpendicular” and “orthogonal” generally describe a relationship between two geometric constructions (e.g., two lines, two planes, a line and a plane, or the like) in which the two geometric constructions are disposed at substantially 90°. For example, a line is said to be perpendicular to another line when the lines intersect at an angle substantially equal to 90°. Similarly, when a planar surface (e.g., a two dimensional surface) is said to be orthogonal to another planar surface, the planar surfaces are disposed at substantially 90° as the planar surfaces extend to infinity.

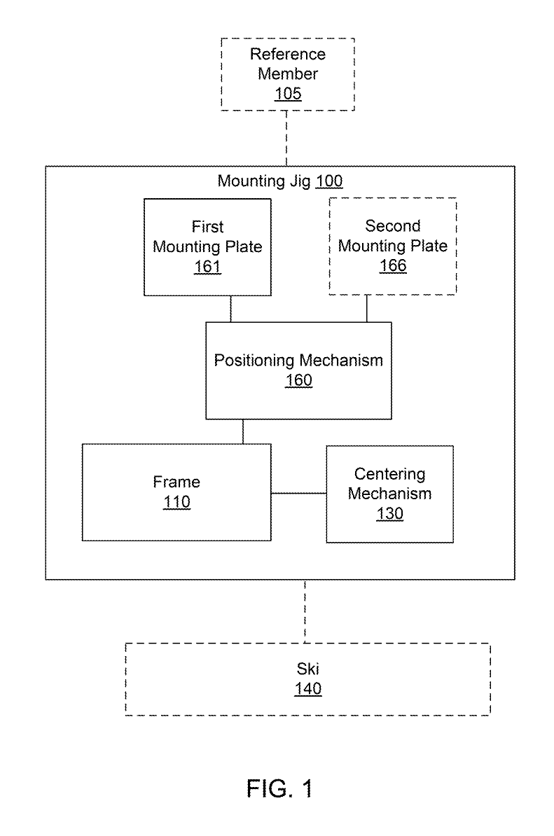

FIG. 1 is a schematic illustration of a mounting jig 100 according to an embodiment. The mounting jig 100 (also referred to herein as “jig”) can be used, for example, to facilitate the mounting of one or more bindings to a ski 140 (e.g., a snow ski). More specifically, the jig 100 can be selectively placed in contact with and/or at least temporarily coupled to the ski 140 to provide a guide or template for drilling holes into the ski 140 that can be used to mount one or more bindings thereto. As shown in FIG. 1, the jig 100 includes a frame 110, a centering mechanism 130 and a positioning mechanism 160 each coupled to he frame 110, and at least one mounting plate 161 that can be selectively and removably coupled the positioning mechanism 130 as describe din more detail below.

The frame 110 can be any suitable shape, size, or configuration and can be formed from any suitable material using any suitable manufacturing technique. For example, in some embodiment, the frame 110 can be formed from aluminum, aluminum alloy, steel, stainless steel, and/or the like that can be bent, extruded, milled, turned, punched, etc., or combination thereof. In some embodiments, the frame 110 can be formed from a composite material, a plastic, a fiber (e.g., fiberglass, carbon fiber, etc.), and/or the like that can be formed using any suitable technique.

The frame 110 is configured to be placed in contact with a surface of the ski 140 when the jig 100 is coupled thereto. For example, in some instances, the frame 110 can be placed in contact with a surface of the ski 140 to which one or more ski bindings can be coupled. In some embodiments, the frame 110 can include indicia (e.g., a tick mark, an arrow, text, line, etc.) that can be associated with, for example, a centerline of the frame 110. In some instances, the frame 110 can be placed in contact with the surface of the ski 140 such that the indicia of the frame 110 is substantially aligned with indicia (e.g., denoting common boot or binding locations) on the ski 140, as described in further detail herein.

As described above, the centering mechanism 130 is coupled to the frame 110 of the jig 100. In some embodiments, the centering mechanism 130 can be configured to move relative to the frame 110 to temporarily couple the jig 100 to the ski 140. The centering mechanism 130 can have various suitable configurations. For example, in some embodiments, the centering mechanism 130 can include a first arm and a second arm (each not shown in FIG. 1) that can be moved relative to the frame 110. In some embodiments, the first arm and the second arm can each include an engagement portion that can be selectively placed in contact with a first side (not shown) of the ski 140 and a second side (not shown) of the ski 140, respectively, to couple the jig 100 to the ski 140. More specifically, the first arm and the second arm can be moved relative to one another to increase or decrease a space defined between the engagement portion of the first arm and the engagement portion of the second arm. For example, in some instances, the first arm can be moved in a first direction to place its engagement portion in contact with the first side of the ski 140 and the second arm can be moved in a second direction, opposite the first direction, to place its engagement portion in contact with the second side of the ski 140. Thus, the first and second arms of the centering mechanism 130 can be moved to couple the jig 100 to the ski 140. In some instances, the first arm and the second arm can be moved substantially concurrently and proportionally such that the jig 100 is centered widthwise on ski 140.

In some embodiments, the centering mechanism 130 can include an actuator that can be operable in moving the first arm relative to the second arm to increase or decrease the distance or space defined between the engagement portion of the first arm and the engagement portion of the second arm. In such embodiments, the actuator can be a lever, a knob, and/or the like that can include or can be coupled to a gear that can engage, for example, a rack included in or defined by the first arm and the second arm. In this manner, rotation of the actuator can rotate the gear relative to the rack of the arms, thereby advancing the arms in a linear motion. Similarly stated, the actuator and the arms can be arranged in a rack and pinion configuration. Further details regarding the operation of the centering mechanism 130 is described below with reference to specific embodiments.

In some embodiments, the first arm and the second arm can be disposed on opposite sides of the actuator such that rotation of the actuator (and the gear) in a first rotational direction (e.g., clockwise) can move the first arm in a first linear direction and can move the second arm in a second linear direction that is parallel and opposite to the first linear direction. Similarly, when the gear is rotated in a second rotational direction (e.g., counterclockwise) the first arm can be moved in the second linear direction and the second arm can be moved in the first linear direction. Thus, the actuator can be actuated to decrease the space defined between the engagement portion of the first arm and the engagement portion of the second arm to an extent that the engagement portion of the first arm and the engagement portion of the second arm clamp the ski 140 therebetween. Said another way, the actuator can be actuated to move the first arm and the second arm such that the engagement portion of the first arm and the engagement portion of the second arm exert a substantially equal and opposite force on the first side and the second side, respectively, of the ski 140 that is sufficient to couple the jig 100 thereto. The centering mechanism 130 can also include a lock mechanism to lock the jig 100 in position on the ski 140.

The positioning mechanism 160 can be various suitable configurations. The positioning mechanism 160 can be used to position a mounting plate 161 along a length of the ski 140 (e.g., substantially orthogonal to the width of the ski 140 described above). The mounting plate 161 is configured to be removably coupled to the positioning mechanism 160. For example, in some embodiments, the mounting plate 161 can define one or more apertures that can receive a portion of the positioning mechanism 160. In this manner, at least the portion of the positioning mechanism 160 can be moved relative to the frame 110 to move the mounting plate 161 in a lengthwise direction relative to the ski 140.

The mounting plate 161 can include a tab or stop member configured to be placed in contact with a portion (e.g., a front or rear end) of a reference member 105. The reference member 105 can be, for example, a ski boot or an object having a length that can be used for facilitating the positioning and attachment of a demo binding (e.g., as used by ski shops). Therefore, when the reference member 105 is in contact with the stop member of the mounting plate 161, movement of at least the portion of the positioning mechanism 160 moves the reference member 105 in a lengthwise direction relative to the ski 140. In some instances, the reference member 105 and the ski 140 can each include indicia (e.g., tick marks, gradation, text, arrows, etc.) associated with a relative position. For example, the reference member 105 can include a tick mark associated with a relative lengthwise center of the reference member 105 (e.g., the center lengthwise of a sole of a ski boot) and the ski 140 can include a set of tick marks associated with common positions of the reference member 105 (e.g., ski boot) relative to the ski 140. Thus, at least the portion of the positioning mechanism 160 can be moved to align the indicia on the reference member 105 with the indicia on the ski 110 such that the reference member 105 will be in the desired position along the length of the ski 140. Moreover, with the indicia of the frame 110 aligned with the indicia of the ski 140, the indicia of the reference member 105, the frame 110, and the ski 140 can all be substantially aligned.

The mounting plate 161 can be any suitable shape, size, or configuration. For example, in some embodiments, the mounting plate 161 can have a shape, size, or configuration that substantially corresponds with a specific binding (not shown) to be mounted to the ski 140. For example, the mounting plate 161 can define a set of holes that are arranged in a specific pattern associated with a mounting portion of a specific binding (e.g., a pattern of mounting holes defined by the binding). Thus, with the jig 100 centered relative to the width of the ski 140 (e.g., by the centering mechanism 130 described above), and with the positioning mechanism 160 disposed at a desired and with the mounting plate 161 coupled to the positioning mechanism 160, the set of holes (also referred to herein as “guide openings”) defined by the mounting plate 161 can provide a guide or template associated with positions at which holes can be drilled into the ski 140 to mount the binding. Similarly stated, the mounting plate 161 can be removably coupled to the positioning mechanism 160 of the jig 100 at a desired location along the length of the ski 140 such that a drill bit or the like can be passed through the set of holes defined by the mounting plate 161 to drill mounting holes into a surface of the ski 140. After the holes have been drilled, the jig 100 can be decoupled from the ski 140 and the binding can be mounted to the ski 140 using the mounting holes drilled into the surface of the ski 140 (as positioned by the mounting plate 161 of the jig 100). Because the reference member 105 was previously aligned with the ski 140 (as described above), the position of the binding can be associated with the desired position of the reference member 105 (e.g., ski boot) relative the ski 140. For example, as discussed above, indicia on the reference member 105 can be aligned with any suitable part of the indicia on the ski 140.

Although described above as including a single mounting plate 161, in some embodiments, the jig 100 can include the mounting plate 161 (e.g., also referred to herein as a “first mounting plate”) and a second mounting plate 166. The second mounting plate 166 can be substantially similar in function as the first mounting plate 161. The second mounting plate 166 can be removably coupled to the positioning mechanism 160 in a similar manner as described above with reference to the first mounting plate 161. In such embodiments, the positioning mechanism 160 can be configured to move the first mounting plate 161 and the second mounting plate 166 in a lengthwise direction of the ski 10. In some instances, the arrangement of the positioning mechanism 160 and the mounting plates 161 and 166 can be such that the first mounting plate 161 and the second mounting plate 166 move substantially concurrently and proportionally in opposite directions. Said another way, the positioning mechanism 160 can move the first mounting plate 161 in a first direction and can move the second mounting plate 166 in a second direction, opposite the first direction such that the first mounting plat 161 and the second mounting plate 166 can be moved closer or farther apart from each other. For example, in some embodiments, the positioning mechanism 160 can include a first shuttle coupled to the first mounting plate 161, a second shuttle coupled to the second mounting plate 166, and a track. In such embodiments, the first shuttle can be configured to move in the first direction along the track while the second shuttle can be configured to move in the second direction along the track and vice versa. In some embodiments, the track can be, for example, a belt, a chain, a tether, a band, a channel, and/or the like.

In some embodiments, the first shuttle and the second shuttle can be coupled to the track such that movement of the first shuttle in the first direction moves the second shuttle an equal distance in the second direction and vice versa. In this manner, the first mounting plate 161 and the second mounting plate 166 can be moved substantially concurrently such that a stop member of the first mounting plate 161 (described above) engages a first portion (e.g., a front end) of the reference member 105 and a stop member of the second mounting plate 166 engages a second portion (e.g., a rear end) of the reference member 105. As such, the reference member 105 can be placed on the mounting plates 161 and 162 within the positioning mechanism 160 such that the reference member 105 is centered relative to the frame 110. Expanding further, by moving the first mounting plate 161 and the second mounting plate 166 an equal distance in parallel but opposite directions, the positioning mechanism 160, the first mounting plate 161, and the second mounting plate 166 can center a reference member 105 (e.g., ski boot) of any suitable size relative to the frame 110.

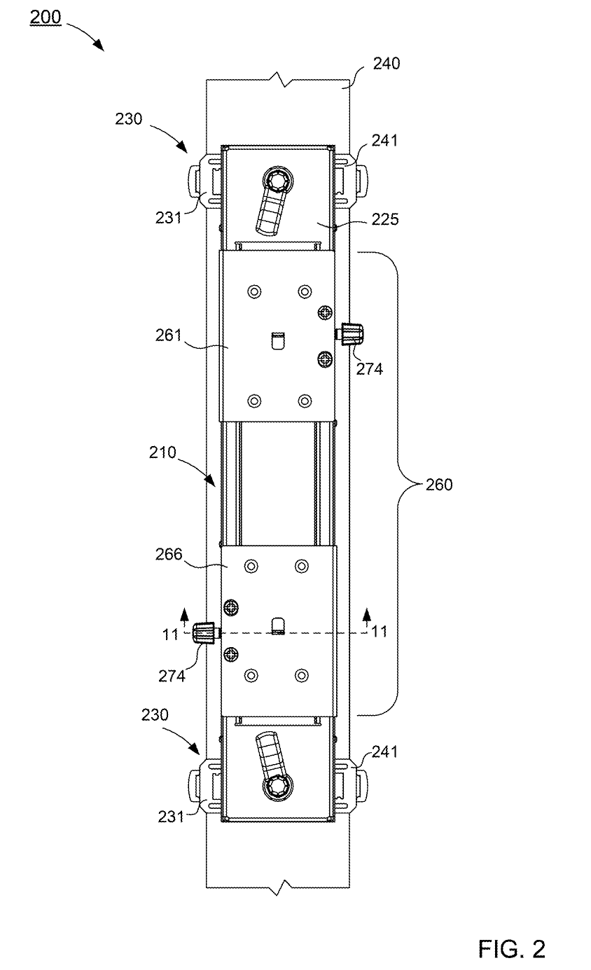

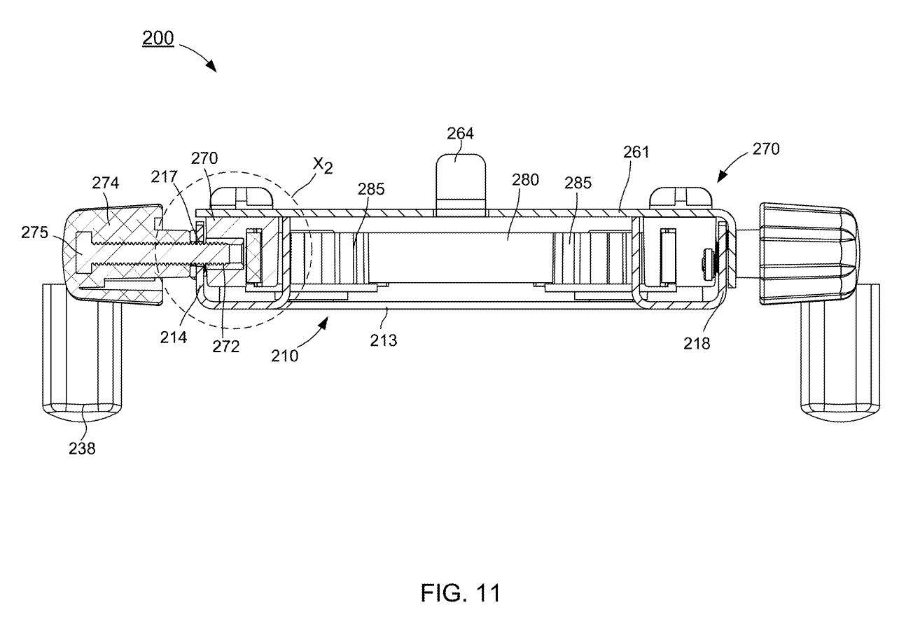

FIGS. 2-16 illustrate a mounting jig 200 according to an embodiment. The mounting jig 200 (also referred to herein as “jig”) can be used, for example, to facilitate the mounting of ski bindings to a ski 240 (e.g., a snow ski). More specifically, the jig 200 is configured to accommodate various boot-binding-ski configurations to facilitate the mounting of bindings at a desired position along a length and width of the ski 240. As shown in FIG. 2, the jig 200 includes a frame 210, a pair of centering mechanisms 230, a positioning mechanism 260, a cover 225, and a pair of mounting plates 261 and 266. The frame 210 can be any suitable shape, size, or configuration and can be formed from any suitable material using any suitable manufacturing technique. For example, in some embodiment, the frame 210 can be formed from aluminum, aluminum alloy, steel, stainless steel, and/or the like that can be bent, extruded, milled, turned, punched, etc., and/or any combination thereof. In some embodiments, the frame 210 can be formed from a composite material, a plastic, a fiber (e.g., fiberglass, carbon fiber, etc.), and/or the like that can be formed using any suitable technique.

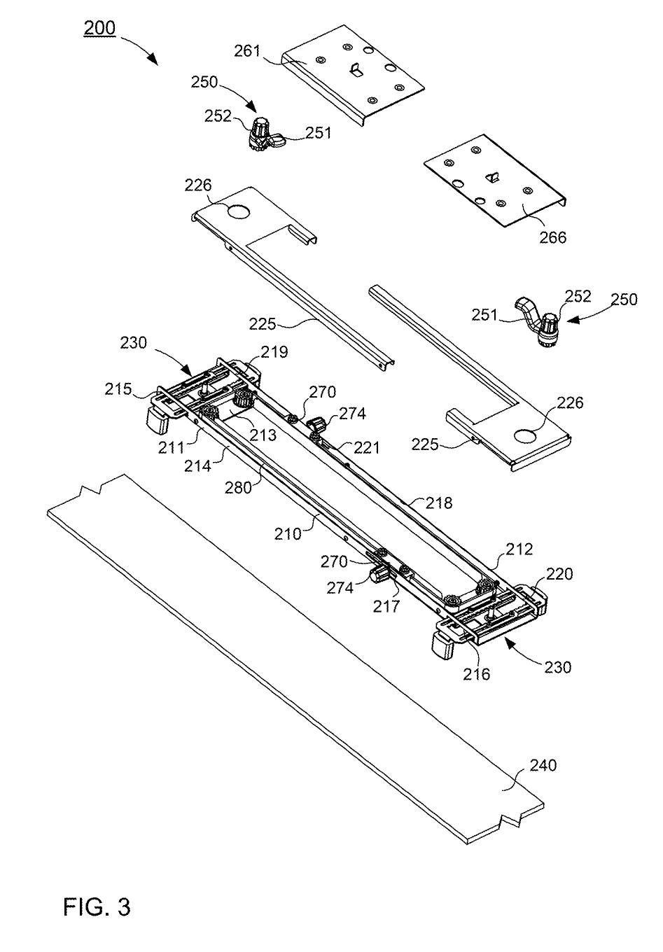

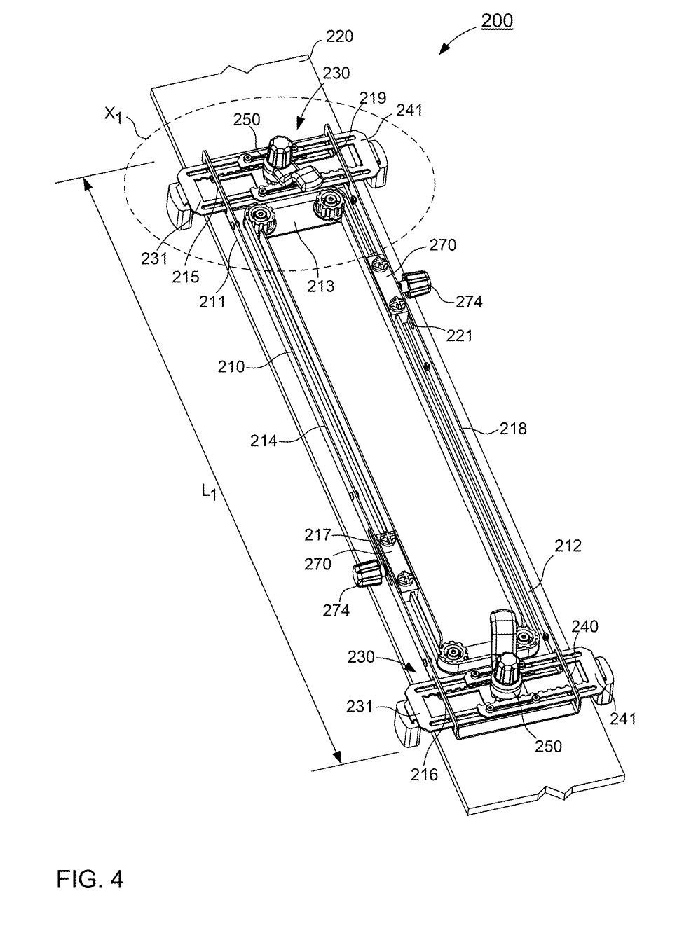

The frame 210 has a first end portion 211 and a second end portion 212 (shown in FIGS. 3 and 4). A first centering mechanism 230 is movably coupled to the first end portion 211 and a second centering mechanism 230 is movably coupled to the second end portion 212 (see e.g., FIGS. 2 and 3), as described in further detail herein. As shown in FIGS. 2-4, the frame 210 includes a base 213 (shown in FIGS. 3 and 4), a first wall 214, and a second wall 218. The frame 210 can be disposed on a ski 240 when the jig 200 is coupled thereto. For example, as shown in FIGS. 2 and 4, in some embodiments the base 213 of the frame 210 can be placed in contact with a surface of the ski 240 to which one or more bindings can be coupled. In some embodiments, the base 213 can be disposed above the top surface of the ski 240. As shown in FIGS. 2 and 3, the cover 225 can be coupled to the frame 210 to substantially enclose at least a portion of the jig 200. Furthermore, the cover 225 defines a set of openings 226 through which a portion of the centering mechanisms 230 can extend, as described in further detail herein.

The first wall 214 and the second wall 218 each extend substantially perpendicular relative to a top surface of the base 213. For example, the first wall 214 and the second wall 218 can extend from a first outer edge and a second outer edge, respectively, of the base 213. More specifically, the walls 214 and 218 extend from opposite sides of the base 213 along a length L₁ of the frame 210 (e.g., substantially the entire length of the frame 210), as shown in FIG. 4. Although the ends of the frame 210 are shown as not including a set of walls, in other embodiments, each side around the perimeter of the base 213 can include and/or otherwise be coupled to a set of walls. In some embodiments, the walls 214 and 218 may not extend the entire length L₁ of the frame 210. As shown in FIGS. 3 and 4, the first wall 214 of the frame 210 defines a first opening 215 defined at or along the first end portion 211 of the frame 210, a second opening 216 defined at or along the second end portion 212 of the frame 210, and a slot 217. The first opening 215 and the second opening 216 can be substantially similar or the same in size and/or shape or can be different in size and/or shape. The first opening 215 receives a portion of the centering mechanism 230 disposed at the first end portion 211 of the frame 210 and the second opening 216 receives a similar portion of the centering mechanism 230 disposed at the second end portion 212 of the frame 210. The slot 217 receives a portion of the positioning mechanism 260, as described in further detail herein.

The second wall 218 is arranged in a substantially mirrored orientation relative to the first wall 214. Thus, the second wall 218 defines a first opening 219 at or along the first end portion 211 of the frame 210, a second opening 220 at or along the second end portion 212 of the frame 210, and a slot 221. As described above, the first opening 219 receives a portion of the centering mechanism 230 disposed at the first end portion 211 of the frame 210, the second opening 220 receives a portion of the centering mechanism 230 disposed of the second end portion 212 of the frame 210, and the slot 221 receives a portion of the positioning mechanism 260, as described in further detail herein.

Although not shown in FIGS. 2-16, in some embodiments, the frame 210 can include indicia (e.g., a tick mark, an arrow, text, etc.) that can be associated with, for example, a midpoint along the length L₁ of the frame 210. Said another way, the indicia can be configured to indicate a center or substantially the center of the frame 210. In some instances, the frame 210 can be disposed on the ski 240 such that the indicia of the frame 210 is substantially aligned with indicia (e.g., denoting boot or binding locations) on the ski 240, as described in further detail herein.

As described above, the jig 210 includes the pair of centering mechanisms 230. The centering mechanisms 230 are substantially similar or the same in form and function. Therefore, a discussion of one of the centering mechanisms 230 (e.g., the centering mechanism 230 movably coupled to the first end portion 211 of the frame 210) applies to both the centering mechanisms 230 unless expressed otherwise.

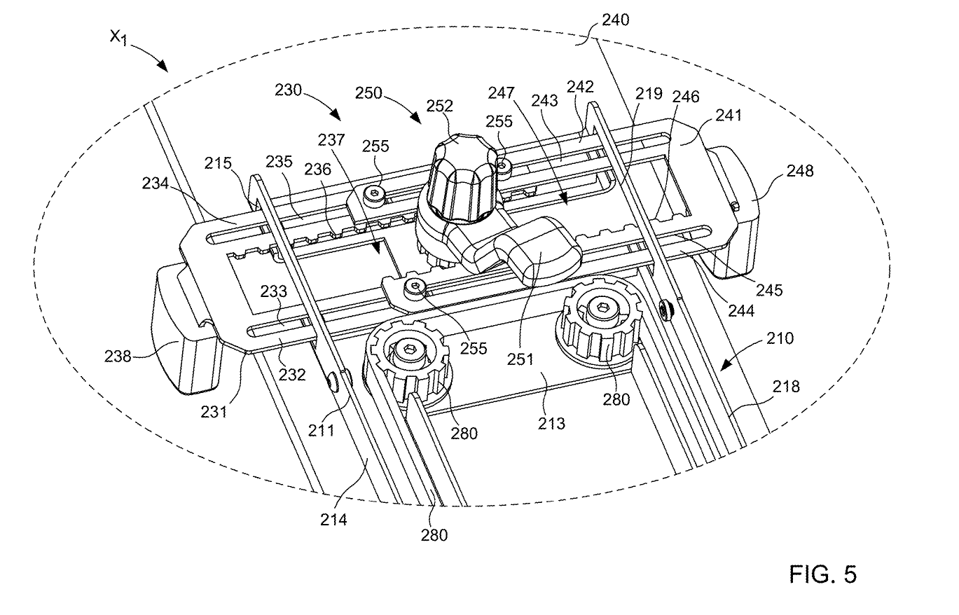

The centering mechanism 230 is coupled to the frame 210 and can be moved relative to the frame 210 to temporarily couple the jig 200 to the ski 240. The centering mechanism 230 can be various suitable configurations. For example, as shown in FIGS. 4-8, the centering mechanism 230 includes a first clamp member 231, a second clamp member 241, and an actuator 250. As described in further detail herein, the actuator 250 can be manipulated to move the first clamp member 231 (also referred to herein as “first clamp mechanism” or “first clamp arm”) and the second clamp member 241 (also referred to herein as “second clamp mechanism” or “second clamp arm”) relative to the frame 210 to couple the jig 200 to the ski 240. The first clamp member 231 and the second clamp member 241 can be substantially similar or the same in form and function and can be arranged in a substantially mirrored orientation relative to the frame 210. Furthermore, as shown in FIGS. 4 and 5, the centering mechanism 230 can be arranged such that a portion of the first clamp member 231 is movably disposed in the first opening 215 of the first wall 214 and the second clamp member 241 is movably disposed in the first opening 219 of the second wall 218.

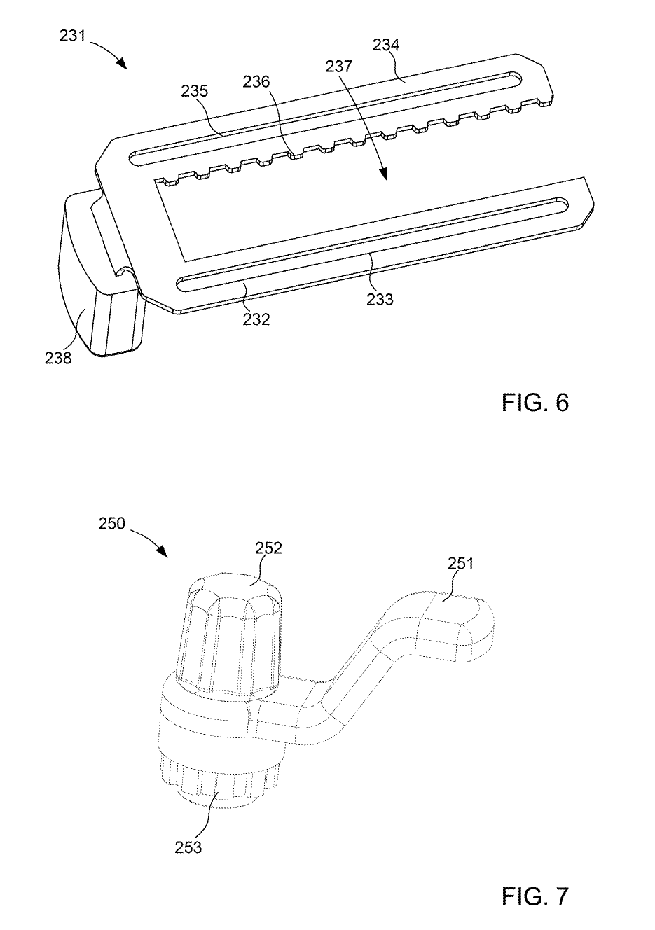

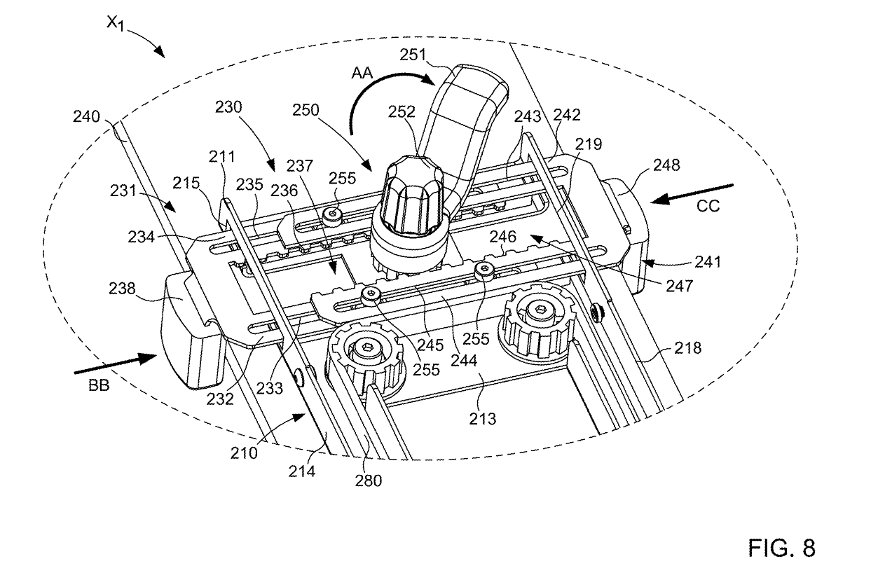

As shown in FIGS. 5 and 6, the first clamp member 231 includes a first arm 232, a second arm 234, and an engagement portion 238. The engagement portion 238 can be, for example, a tab or flange that can extend substantially perpendicular relative to the arms 232 and 234 to be selectively placed in contact with a surface (e.g., a side edge) of the ski 240 (see e.g., FIG. 8), as described in further detail herein. In some embodiments, the engagement portion 238 can be coupled to or otherwise include a bumper or the like that can be formed from a relatively flexible material. In such embodiments, the bumper can be placed in contact with a surface (e.g., side edge) of the ski 240 to prevent scratching or damage of the ski 240 during use of the jig 200.

The first arm 232 and the second arm 234 are arranged in a substantially parallel orientation relative to one another. Furthermore, as shown in FIGS. 5 and 6, the first arm 232 defines a slot 233 that is substantially parallel to a slot 235 defined by the second arm 234. In this manner, one or more couplers 255 (e.g., a mechanical fastener such as a bolt, screw, rivet, clip, pin, and/or the like) can be at least partially disposed within the slot 233 of the first arm 232 and the slot 235 of the second arm 234 to slidably couple the first clamp member 231 to the base 213. For example, in some embodiments, the couplers 255 can be bolts that can be inserted into the slots 233 and 235 such that a first end portion of the couplers 255 (e.g., a bolt head or the like) is disposed above a top surface of the arms 232 and 234, respectively, and a second end portion, opposite the first end portion, of the couplers 255 extends through the slots 233 and 235 to define a threaded coupling with a portion of the base 213 (e.g., a threaded nut or opening). As a result, the first clamp member 231 is slidably coupled to the base 213 and can be slid through the opening 215 defined by the first wall 214. This slidable coupling allows the engagement portion 238 to be moved closer to or farther away from the side edge of the ski 240, as described in further detail below.

The parallel arrangement of the first arm 232 and the second arm 234 of the first clamp member 231 is such that a space defined between an inner surface of the first arm 232 and an inner surface of the second arm 234 defines a void 237 that receives a portion of the actuator 250. More particularly, as shown in FIG. 6, the first arm 232 has a substantially smooth or substantially linear inner surface while the inner surface of the second arm 234 includes a set of protrusions or teeth 236. The protrusions 236 can be, for example, substantially uniform and can be disposed along a length (or a portion of the length) of the second arm at a substantially consistent spacing. As such, the protrusions 236 can be configured to engage a portion of the actuator 250, when the actuator 250 is disposed within the void 237, as described in further detail below.

The second clamp member 241 of the centering mechanism 230 is substantially similar to or the same as the first clamp member 231. Therefore, the second clamp member 241 is briefly described herein and should be considered the same as the first clamp member 231 unless explicitly described otherwise. As shown in FIG. 5, the second clamp member 241 includes a first arm 242, a second arm 244, and an engagement portion 248. The engagement portion 248 can be a tab or the like, as described above with reference to the first clamp member 231. Similarly, the first arm 242 and the second arm 244 are in a similar arrangement as described above with reference to the first arm 232 and the second arm 234 of the first clamp member 231. As such, the first arm 242 and the second arm 244 each define a slot 243 and 245, respectively, which can receive the couplers 255. Moreover, the inner surface of the second arm 244 includes a set of protrusions 246 that are configured to engage the actuator 250 when the actuator 250 is disposed within a void 247 defined between the first arm 242 and the second arm 244, as similarly described above with reference to the first clamp member 231.

The actuator 250 of the centering mechanism 230 can be any suitable device or mechanism that can be manipulated to move the first clamp member 231 and/or the second clamp member 241 relative to the frame 210. For example, as shown in FIG. 7, the actuator 250 can include a lever 251, a retention knob 252, and a pinion 253. Although not shown in FIGS. 4-8, the retention knob 252 can include or can be operably coupled to a bolt or the like that can define a threaded coupling with a portion of the base 213. In this manner, the retention knob 252 can be rotated relative to the lever 251 to allow (e.g., unlock) or to limit (e.g., lock) rotational movement of the actuator 251. For example, the retention knob 252 can be rotated in a first direction such that more threads of the bolt (not shown) engage the portion of the base 213, thereby moving the retention knob 252 towards the base 213 and increasing a force exerted by the retention knob 252 on the lever 251. Conversely, the retention knob 252 can be rotated in a second direction, opposite the first direction such that fewer threads of the bolt engage the portion of the base 213, thereby moving the retention knob 252 away from the base and decreasing the force exerted by the retention knob 252 on the lever 251. In this manner, the retention knob 252 can be rotated between a first configuration in which the force exerted by the retention knob 252 on the lever 251 is sufficient to substantially limit rotation of the lever 251 and a second configuration in which the force exerted by the retention knob 252 is not sufficient to substantially limit rotation of the lever 251.

As described above, the pinion 253 of the actuator 250 is configured to engage the first clamp member 231 and the second clamp member 241. More particularly, when the actuator 250 is disposed in the void 237 defined by the first clamp member 231 and the void 247 defined by the second clamp member 241, the pinion 253 engages the protrusions 236 of the first clamp member 231 and the protrusions 246 of the second clamp member 241, respectively. For example, in some embodiments, the retention knob 252 can be placed in the second configuration, thereby allowing the lever 251 to be rotated relative to the base 213. The rotation of the lever 251 rotates the pinion 253 about the bolt (not shown) that couples the retention knob 252 to the base 213. As the pinion 253 is rotated, the protrusions 236 of the first clamp member 231 and the protrusions 246 of the second clamp member 241 sequentially engage the pinion 253 to linearly move the first clamp member 231 and the second clamp member 241, respectively, relative to the actuator 250. For example, as shown in FIGS. 5 and 8, the lever 251 of the actuator 250 can be rotated in a first direction (as indicated by the arrow AA in FIG. 8) to linearly move the first clamp member 231 from a first position (shown in FIG. 5) to a second position (shown in FIG. 8) to bring the engagement portion 238 into contact with a first side of the ski 240, as indicated by the arrow BB in FIG. 8. Moreover, the mirrored arrangement of the first clamp member 231 and the second clamp member 241 is such that the protrusions 246 of the second clamp member 241 are disposed opposite the protrusions 236 of the first clamp member 231. Thus, as shown in FIG. 8, rotation of the lever 251 moves the second clamp member 241 in a direction that is opposite the direction of motion of the first clamp member 231, as indicated by the arrow CC in FIG. 8. As a result, the engagement portion 248 of the second clamp member 241 can be brought into contact with a second side of the ski 240, opposite the first side of the ski. In this manner, the lever 251 of the actuator 250 can be rotated to an extent that the engagement portion 238 of the first clamp member 231 and the engagement portion 248 of the second clamp member 241 exert an equal but opposite force on the respective sides of the ski 240 that is sufficient to at least temporarily couple the jig 200 to the ski 240. As described in further detail herein, the actuator 250 can be rotated in a direction that is substantially opposite of the direction AA in FIG. 8 to remove the engagement portions 238 and 248 from contact with the first side and the second side, respectively, of the ski 20, thereby allowing the jig 200 to be decoupled from the ski 240.

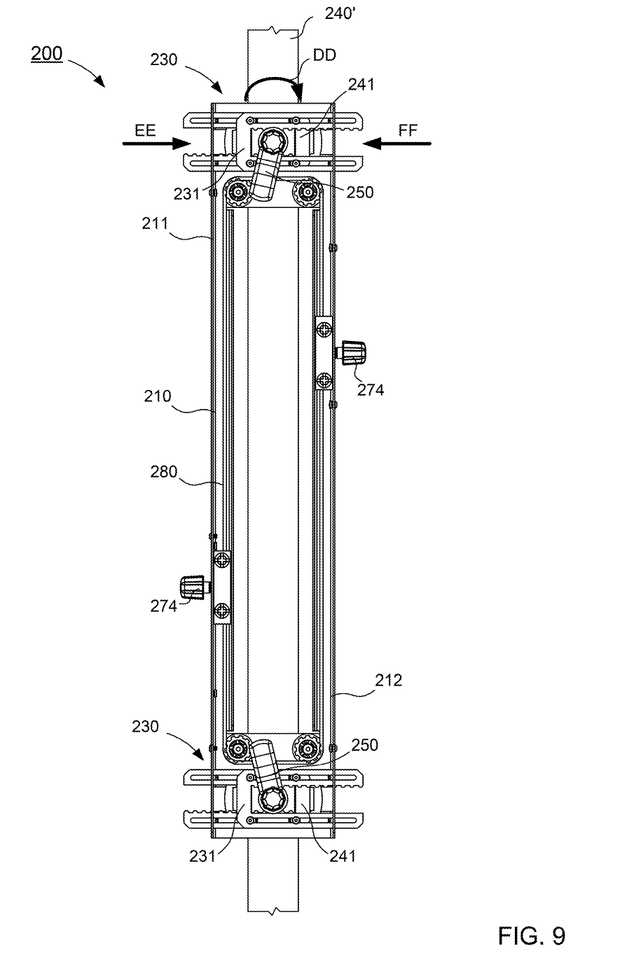

The arrangement of the centering mechanism 230 can be such that as the actuator 250 is manipulated, the first clamp member 231 and the second clamp member 241 are moved substantially concurrently and proportionally in opposite directions. In this manner, the centering mechanism 230 can automatically center the first end portion 211 of the frame 210 relative to the ski 240. Moreover, the arrangement of the centering mechanism 230 can be such that when the actuator 250 is manipulated, the centering mechanism 230 can automatically center at least a portion of the jig 200 on a ski having various different widths and/or thicknesses. For example, as shown in FIG. 9, in some instances, the jig 200 can be coupled to a ski 240′ having a relatively small width. In such instances, the actuator 250 can be rotated in, for example, a clockwise direction (as indicated by the arrow DD in FIG. 9) to move the first clamp member 231 and the second clamp member 241 relative to the ski 30. More particularly, as shown in FIG. 9, the actuator 250 can be rotated a sufficient amount to move the first clamp member 231 in a first direction (as indicated by the arrow EE) such that the engagement portion 238 is placed in contact with a first side of the ski 240′ as well as a sufficient amount to move the second clamp member 241 in a second direction, opposite the first direction (as indicated by the arrow FF), such that the engagement portion 238 is placed in contact with a second side of the ski 30, opposite the first side of the ski 30. Thus, the centering mechanism 230 can center the jig relative to a ski and couple the jig to the ski regardless of the width of the ski. Although not described in detail herein, the centering member 230 that is movably coupled to the second end portion 212 of the frame 210 can be similarly manipulated to couple and center the second end portion 212 of the frame 210 to the ski 240 (or ski 240′).

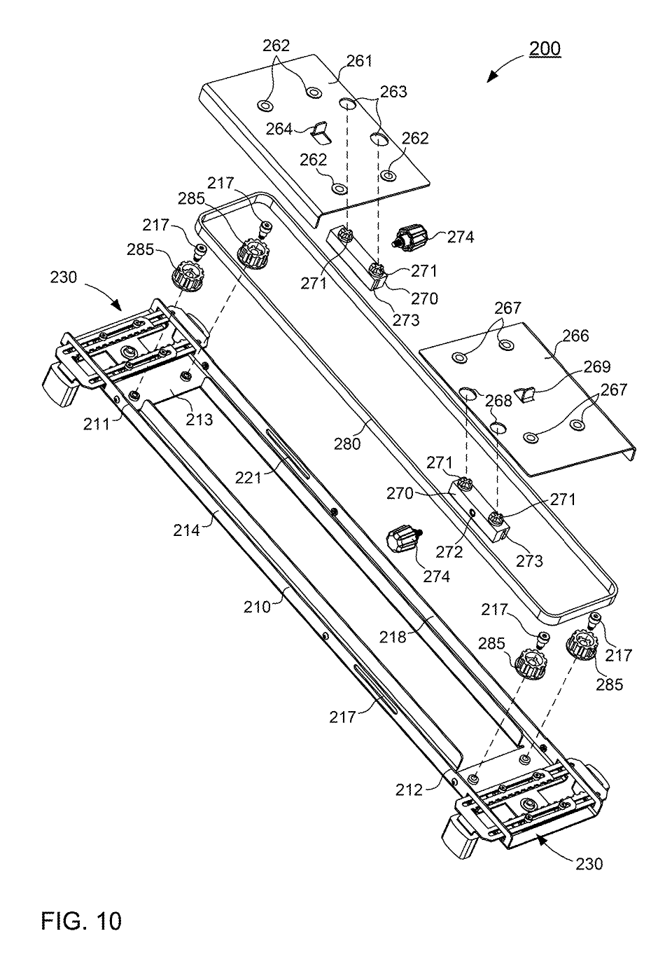

As shown in FIGS. 10-16, the positioning mechanism 260 of the jig 200 is operably coupled to the frame 210. The positioning mechanism 260 can be various different configurations. The positioning mechanism 260 can be used to position the mounting plates 261 and 266 lengthwise on the jig 200 along a length of a ski (e.g., substantially perpendicular to the width of the ski). As shown in FIG. 10, the positioning mechanism 260 includes a pair of shuttles 270, a set of gears 285, and a drive member 280. The gears 285 are rotatably coupled to the base 213 of the frame 210. For example, in some embodiments, a coupling member 227 (see e.g., FIG. 10) such as a mechanical fastener (e.g., a screw, bolt, and/or the like) can extend through an aperture defined by the gears 285 to define a threaded coupling with, for example, a PEW® Nut included in the base 213. In this manner, the gears 285 can be rotated about the coupling member 227, as described in further detail herein.

The drive member 280 of the positioning mechanism 260 can be any suitable band or the like that can be rotated relative to the frame 210. For example, in some embodiments, the drive member 280 can be a belt with an inner surface that includes and/or otherwise defines a set of substantially equally spaced and equally sized protrusions that are configured to sequentially engage the gears 285. Expanding further, in some embodiments, the drive member 280 can be stretched around the gears 285 such that a desired tension is defined along a length of the drive member 280. The tension along the length of the drive member 280 can be sufficiently large to substantially limit and/or prevent the drive member 280 from slipping relative to the gears 285. In other words, the arrangement of the gears 285 and the drive member 280 can be such that rotation of the drive member 280 rotates the gears 285 in a substantially concurrent and proportional manner. Furthermore, the gears 285 can include and/or define a set of protrusions or teeth that can engage, for example, the protrusions of the drive member 280 such that slipping of the drive member 280 along a surface of the gears 285 is substantially limited. Although the drive member 280 is described above as being a belt, in other embodiments, the drive member 280 can be a chain, a band, a tether, and/or any suitable kinematic linkage.

The shuttles 270 of the positioning mechanism 260 can be any suitable shape, size, or configuration, and can be operably coupled to the frame 210 and the drive member 280. More particularly, the shuttles 270 define a slot 273 that receives a portion of the drive member 280 to couple the shuttle 270 thereto, as shown, for example, in FIGS. 10-12. In some embodiments, the arrangement of the shuttles 270 can be such that an inner surface defines at least a portion of the slot 273 and includes and/or defines a set of protrusions, teeth, grooves, etc. that can engage, for example, the protrusions of the drive member 280 when the drive member 280 is disposed in the slot 273. In this manner, the shuttles 270 can be fixedly coupled to the drive member 280. Moreover, as shown in FIG. 10, the arrangement of the pair of shuttles 270 relative to the drive member 280 is such that one shuttle 270 is coupled to a first side of the drive member 280 and the other shuttle 270 is coupled to a second side (opposite the first side) of the drive member 280, in a substantially mirrored orientation. As described in further detail herein, such an arrangement can allow the shuttles 270 to move substantially concurrently and proportionally, in opposite directions, when the drive member 280 is rotated relative to the frame 210.

As shown in FIGS. 10-12, the shuttles 270 define an opening 272 that can receive a portion of a retention knob 274. More specifically, the retention knob 274 includes a threaded portion 275 that can be inserted into the opening 272 defined by each shuttle 270 to define a threaded coupling with a surface of each shuttle 270 defining the opening 272. In some embodiments, the threaded portion 275 can be, for example, a bolt or the like that can be over-molded with, for example, a dissimilar material (e.g., plastic, rubber, nylon, ceramic, thermoplastic, etc.) to form the retention knob 274. The threaded portion 275 can extend, at least partially, beyond a surface of the retention knob 274 to be inserted into the slot 217 defined by the first wall 214 of the frame 210 or the slot 221 defined by the second wall 218 of the frame 210. In other words, one of the shuttles 270 is disposed along the drive member 280 such that at least a portion of that shuttle 270 is adjacent to the slot 217 defined by the first wall 214, thereby allowing the threaded portion 275 of that retention knob 274 to extend through the slot 217 to define the threaded coupling with that shuttle 270. Similarly, the other shuttle 270 is disposed along the drive member 280 such that at least a portion of that shuttle 270 is adjacent to the slot 221 defined by the second wall 218, thereby allowing the threaded portion 275 of that retention knob 274 to extend through the slot 221 to define the threaded coupling with that shuttle 270.

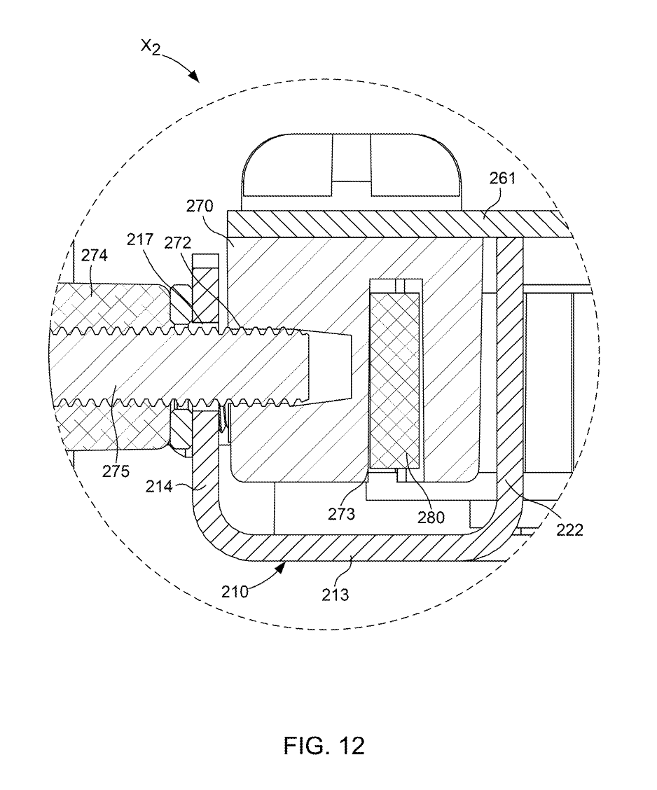

As shown in FIG. 12, the arrangement of the shuttle 270 (only one shuttle 270 is shown in FIG. 12), the retention knob 274, and the first wall 214 is such that the shuttle 270 is disposed adjacent to an inner surface of the first wall 214 and the retention knob 274 is disposed adjacent to an outer surface of the first wall 214. In this manner, the threaded portion 275 of the retention knob 274 can be advanced within the opening 272 of the shuttle 270 to place a surface of the shuttle 270 in contact with the inner surface of the first wall 214 and a surface of the retention knob 274 in contact with the outer surface of the first wall 214, thereby retaining the shuttle 270 in a relatively fixed position relative to the first wall 214. Said another way, when the threaded portion 275 of the retention knob 274 is advanced within the opening 272 of the shuttle 270 the shuttle 270 and/or the retention knob 274 exert a force on the first wall 214 that is sufficient to retain or lock the position of the shuttle 270 relative to the first wall 214. Conversely, the threaded portion 275 of the retention knob 274 can be retracted from a portion of the opening 272 to substantially reduce the force exerted on the first wall 214 (e.g., unlock) and/or to allow the shuttle 270 and/or the retention knob 274 to be removed from contact with the first wall 214 (e.g., either automatically or by a manually applied force). Thus, the force exerted on the first wall 214 can be sufficiently reduced such that the shuttle 270 is no longer retained in a fixed position relative to the frame 210. The other shuttle 270 disposed adjacent to the slot 221 defined by the second wall 218 can be arranged in a similar manner and is, therefore, not described in further detail herein. Although the retention knob 274 is described above as defining a threaded coupling with the shuttle 270, in other embodiments, the retention knob 274 can be any suitable mechanism that can be operably coupled to the shuttle 270 and configured to selectively retain the position of the shuttle 270 relative to the frame 210.

In some instances, the retention knob 274 of each shuttle 270 can be engaged to reduce the force exerted on the walls 214 and 218 of the frame 210 to allow the shuttles 270 to be moved relative to the frame 210, as described above. With the force reduced, the retention knob 274 of either shuttle 270 can be slid relative to the frame 210 to place the threaded portion 275 in a desired location along a length of the slot 217 or slot 221. With the threaded portion 275 at least partially disposed within the opening 272 of the shuttle 270, the movement of the retention knob 274 relative to the frame 210 also moves the shuttle 270 relative to the frame 210. In this manner, the shuttle 270 can be placed in a desired location along the length of the jig 200. Furthermore, with the shuttles 270 fixedly coupled to the drive member 280, movement of one of the shuttles 270 rotates the drive member 280 relative to the frame 210. Thus, as the retention member 274 is moved, the shuttles 270 are moved in a substantially concurrent and proportional manner in opposite directions (e.g., due to the mirrored orientation, as described above). The arrangement of the positioning mechanism 260 and the frame 210 (e.g., the slots 217 and 221) is such that the shuttles 270 are maintained a substantially equal distance from a center of the jig 200 regardless of the position of the shuttles 270 relative to the slots 217 and 221. In other words, a distance between a point on one shuttle 270 and the center of the jig 200 is equal to a distance between a corresponding point (e.g., the equivalent point) on the other shuttle and the center of the jig 200.

Referring back to FIG. 10, the shuttles 270 each include a set of protrusions 271 that can be used to couple the first mounting plate 261 to one shuttle 270 and the second mounting plate 266 to the other shuttle 270. More particularly, the first mounting plate 261 defines a set of apertures 263 that can receive at least a portion of the protrusions 271 of the shuttle 270 to at least temporarily couple the first mounting plate 261 to that shuttle 270. Similarly, the second mounting plate 266 defines a set of apertures 268 that can receive at least a portion of the protrusions 271 of the other shuttle 270. When coupled to the shuttles 270, the first mounting plate 261 and the second mounting plate 266 can be disposed in a substantially mirrored orientation, as described above with reference to the shuttles 270. Thus, with the first mounting plate 261 and the second mounting plate 266 each coupled to one of the shuttles 270, movement of the shuttles 270, as described above, is operable in moving the mounting plates 261 and 266 relative to the frame 210, as described in further detail herein.

The first mounting plate 261 includes a tab 264 and defines a set of guide openings 262. The tab 264 can be various shapes and/or sizes and can act as a stop member for placement of the reference member 225. For example, while shown in FIG. 10 as being a portion of the mounting plate 261 that is bent into a substantially perpendicular orientation relative to a surface of the mounting plate 261, in other embodiments, the tab 264 can be coupled to (e.g., not monolithically formed with the mounting plate 261) to the mounting plate 261. The tab 264 can be used to engage a portion of a reference member (e.g., ski boot) (not shown in FIG. 10), as described in further detail herein. The set of guide openings 262 defined by the mounting plate 261 can be a unique set of apertures associated with, for example, a portion of a set of mounting holes for a specific ski binding. For example, the guide openings 262 can be associated with the holes used to attach a toe portion of the ski binding.

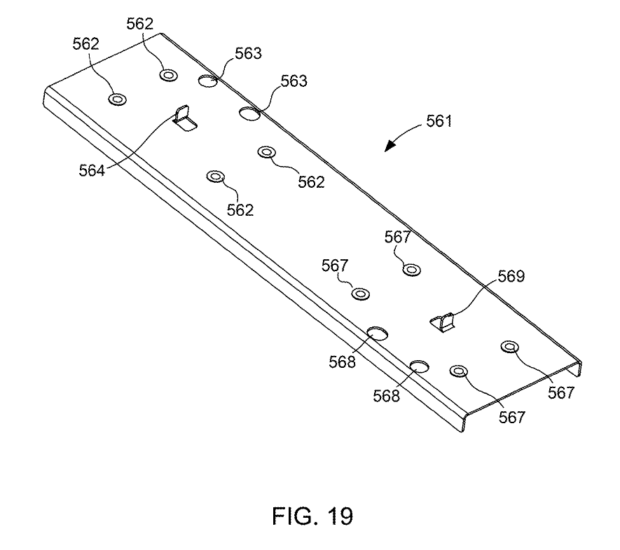

The second mounting plate 266 includes a tab 269 and defines a set of guide opening 267. The tab 269 of the second mounting plate 266 can be similar in function of as the first mounting plate 261 and thus, not described in further detail herein. The set of guide openings 267 can be a unique set of apertures associated with, for example, a portion of a set of mounting holes for a specific ski binding. For example, in this embodiment, the set of guide openings 267 can be associated with holes used to attach a heel portion of a ski binding. Thus, collectively the guide holes 262 of the first mounting plate 261 and the guide holes 267 of the second mounting plate 266 define a unique set of apertures associated with a specific ski binding. In an embodiment in which there is a single mounting plate (see e.g., FIG. 19), the mounting plate can include a set of guide openings that define a unique set of apertures for a particular ski binding and can include the hole pattern for both the toe portion and heel portion of the ski binding.

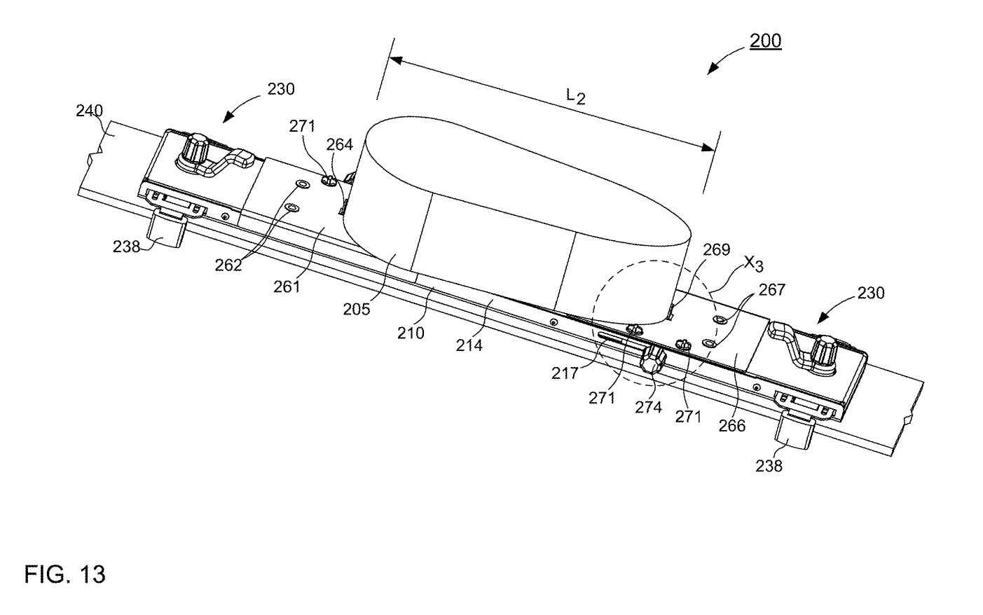

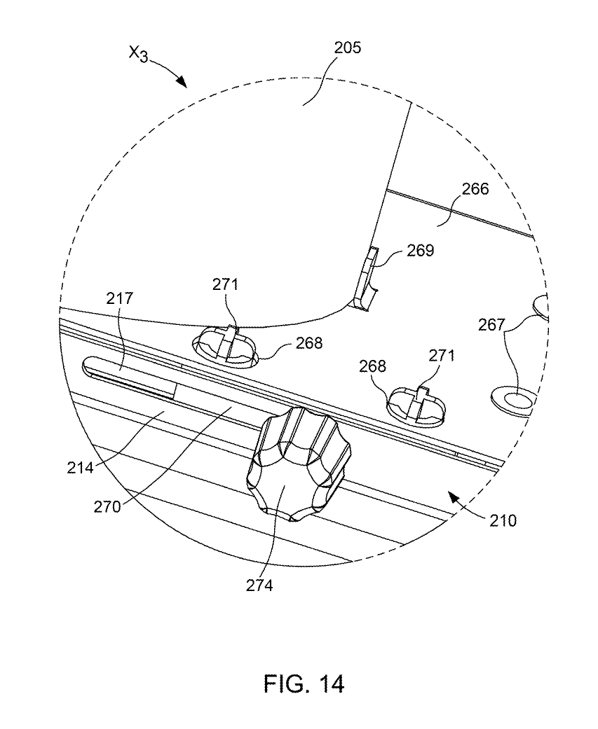

In use, the jig 200 can be used to facilitate the placement of ski bindings in a desired location relative to the ski (e.g., the ski 240). For example, in some instances, the jig 200 can be used to facilitate the placement of ski bindings (not shown) that are associated with a desired placement of a ski boot 205, having a length L₂, as shown in FIGS. 13 and 14. In such instances, the jig 200 can be placed in a desired location relative to the ski 240. For example, as described above, indicia or the like on the frame 210 of the jig 200 (described above) can be aligned with indicia printed on the ski 240. With the jig 200 in the desired position along the length of the ski 240, the centering mechanisms 230 can be manipulated to couple the jig 200 to the ski 240 (e.g., by placing the engagement portions 238 and 248 in contact with the respective sides of the ski 240, as described in detail above). In this manner, the jig 200 can be centered (e.g., automatically due to the arrangement of the centering mechanisms 230) along the width of the ski 240.

With the jig 200 in the desired position widthwise relative to the ski 240, the boot 205 can be placed on at least a portion of the mounting plate 261 and/or the mounting plate 266. For example, in some instances, the boot 205 can be positioned relative to the first mounting plate 261 such that the tab 264 is placed in contact with a front surface of the boot 205 (or alternatively such that the tab 269 is in contact with a back surface of the boot 205). The retention knobs 274 of the shuttle 270 can be engaged to retract the threaded portion 275 from a portion of the opening 272 defined by each shuttle 270, in other words, to unlock the positioning mechanism 260. In some instances, the retention knobs 274 can be retracted prior to placing the boot 205 in contact with the mounting plate 261 and/or 266. Thus, the retention knob 274 can be moved along a length of the associated slot 217 or 221 to an extent that moves the tab 269 of the second mounting plate 266 toward the boot 205 until the tab 269 contacts a back surface of the boot 205 (e.g., opposite the front surface of the boot 205). As described above, the arrangement of the positioning mechanism 260 is such that the shuttles 270 (and therefore, the mounting plates 261 and 266) move in a substantially concurrent and proportional manner in opposite directions. Thus, as the retention knob 274 is moved (e.g., by a user), the first mounting plate 261 and the second mounting plate 266 are each moved further from or towards the center of the jig 200 to an extent that places the tab 264 of the first mounting plate 261 and the tab 269 of the second mounting plate 266 in contact with the front and back surfaces, respectively, of the ski boot 205. Moreover, such an arrangement can automatically center the ski boot 205 lengthwise relative to the jig 200 such that indicia associated with the center (lengthwise) of the boot 205 can be aligned with the indicia on the frame 210 of the jig 200 and the desired indicia on the ski 240.

Once the boot 205 is positioned relative to the ski 240, the retention knobs 274 can be engaged to advance the threaded portion 275 within the opening 272 defined by each shuttle 270 to retain the position of the shuttles 270 and, therefore, the mounting plates 261 and 266 relative to the frame 210. In some instances, the boot 205 can then be removed from the jig 200 to expose the guide openings 262 of the first mounting plate 261 and the guide openings 267 of the second mounting plate 266. Thus, with the position of the mounting plates 261 and 266 substantially fixed, a drill bit can be advanced through the guide openings 262 of the first mounting plate 261 and the guide openings 267 of the second mounting plate 266 to allow a user to drill mounting holes in a desired position in the ski 240, which can be used to attach one or more ski bindings (not shown) to the ski 240. With the mounting holes drilling in a surface of the ski 240, the centering mechanisms 230 can be actuated to decouple the jig 200 from the ski 240 and, once removed, the ski bindings can be coupled to the ski 240 via the drilled mounting holes. In this manner, the jig 200 can be used to facilitate the mounting of ski bindings to a ski in a position that is associated with a desired boot position.

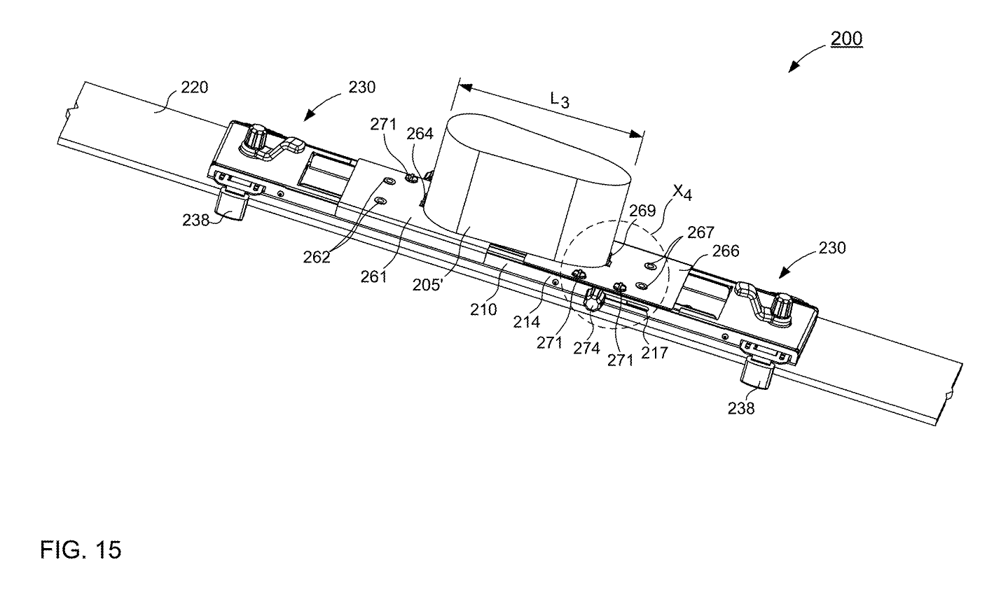

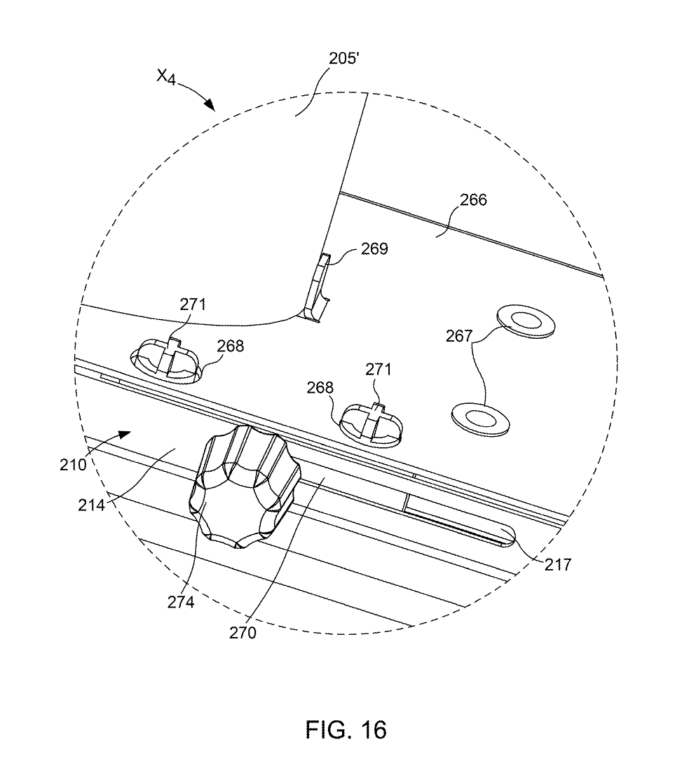

As described above, the jig 200 can be used to facilitate the placement of ski bindings to a ski in a position that is associated with a desired position of any suitably sized boot. For example, FIGS. 15 and 16 illustrate the jig 200 in use to facilitate the placement of ski bindings to the ski 240 that are associated with a desired position of a boot 205′, having a length L₃. As shown, the length L₃ of the boot 205′ is shorter than the length L₂ of the boot 205 of FIGS. 13 and 14. The jig 200 can be placed relative to the ski 240 in a similar manner as described above and the centering mechanisms 230 can be manipulated to couple the jig 200 to the ski 240. After the jig 200 is coupled to the ski 240, the positioning mechanism 260 can be actuated to move the mounting plates 261 and 266 to a position that places a front surface of the boot 205′ in contact with the tab 264 of the first mounting plate 261 and places a back surface of the boot 205′ in contact with the tab 269 of the second mounting plate 266. In this manner, as shown in FIG. 16, the shuttles 270 and thus, the mounting plates 261 and 266 can be placed in a position that is associated, at least partially, with the length L₃ of the boot 205′. With the boot 205′ centered widthwise relative to the jig 200 and at the desired position along the length of the ski 20, the positioning mechanism 260 can be manipulated to retain the position of the shuttles 270 and the mounting plates 261 and 266. Thus, the boot 35 can be removed to expose the guide openings 262 of the first mounting plate 261 and the guide openings 267 of the second mounting plate 266. A drill bit can then be passed through the guide openings 262 and 267 to drill mounting holes into a surface of the ski. The jig 200 can then be decoupled from the ski 240 and the ski bindings can be mounted, as described above.

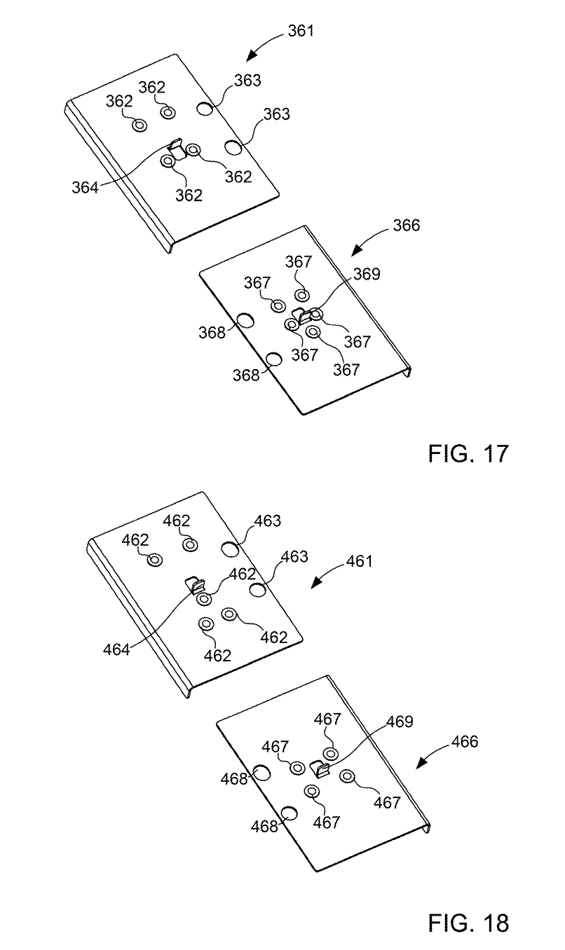

As described above, the mounting plates 261 and 266 are at least temporarily coupled to the shuttles 270 by disposing the protrusions 271 of one of the shuttles 270 in the apertures 263 or 268 of the respective shuttle 270. In some instances, such an arrangement can allow the mounting plates 261 and 266 to be decoupled from the shuttles 270 and a different set of mounting plates associated with a different binding having a different style, type, size, shape, and/or design iteration, etc. For example, FIG. 17 is a perspective view of a first mounting plate 361 and a second mounting plate 366 associated with a specific set of ski bindings that have a different set of unique mounting apertures from the ski bindings associated with the mounting plates 261 and 266. As shown in FIG. 17, the first mounting plate 361 includes a tab 364 and defines a set of apertures 363 and a set of guide openings 362. Similarly, the second mounting plate 366 includes a tab 369 and defines a set of apertures 368 and a set of guide openings 367. The tabs 364 and 369 of the mounting plates 361 and 366, respectively, are configured to be placed in contact with opposite end surfaces of a ski boot, as described above. The apertures 363 and 368 of the mounting plates 361 and 366, respectively, are configured to receive the protrusions 271 of one of the shuttles 270, as described in detail above. The set of guide openings 362 and 367 of the mounting plates 361 and 366, respectively, are associated with a mounting hole pattern of a specific ski binding. Thus, the mounting plates 361 and 366 can be coupled to the positioning mechanism 260 of the jig 200, and the jig 200 can be used to facilitate the placement of the specific bindings and associated with a desired position of a ski boot.

FIG. 18 is a perspective view of a first mounting plate 461 and a second mounting plate 466, according to another embodiment. The first mounting plate 461 and the second mounting plate 466 can be associated with a specific type, style, size, etc. of ski bindings that are different from the ski bindings associated with the mounting plates 261 and 266. As shown in FIG. 18, the first mounting plate 461 includes a tab 464, and defines a set of apertures 463 and a set of guide openings 462. Similarly, the second mounting plate 466 includes a tab 469, and defines a set of apertures 468 and a set of guide openings 467. The tabs 464 and 469 of the mounting plates 461 and 466, respectively, are configured to be placed in contact with opposite surfaces of a ski boot, as described above. The apertures 463 and 468 of the mounting plates 461 and 466, respectively, are configured to receive the protrusions 271 of one of the shuttles 270, as described in detail above, to removably couple the mounting plates 461 and 466 to the positioning mechanism 460. The set of guide openings 462 and 467 of the mounting plates 461 and 466, respectively, are associated with a mounting hole pattern of a specific ski binding. Thus, the mounting plates 461 and 466 can be coupled to the positioning mechanism 260 of the jig 200, and the jig 200 can be used to facilitate the placement of the specific bindings associated with the desired position of a ski boot.

FIG. 19 is a perspective view of a single mounting plate 561 that can be associated with a specific type, style, size, etc. of ski bindings, according to another embodiment. The mounting plate 561 includes a first tab 564 and a second tab 569 that can be used to position, for example, a ski boot, as described above for previous embodiments. The mounting plate 561 defines a set of apertures 563 and 568 and a set of guide openings 562. The apertures 563 and 568 are configured to receive the protrusions 271 of one of the shuttles 270, as described in detail above. The set of guide openings 562 of the mounting plate 561 is associated with a mounting hole pattern of a specific ski binding. Thus, the mounting plate 561 can be coupled to the positioning mechanism 260 of the jig 200, and the jig 200 can be used to facilitate the placement of the specific bindings, as described above for previous embodiments.

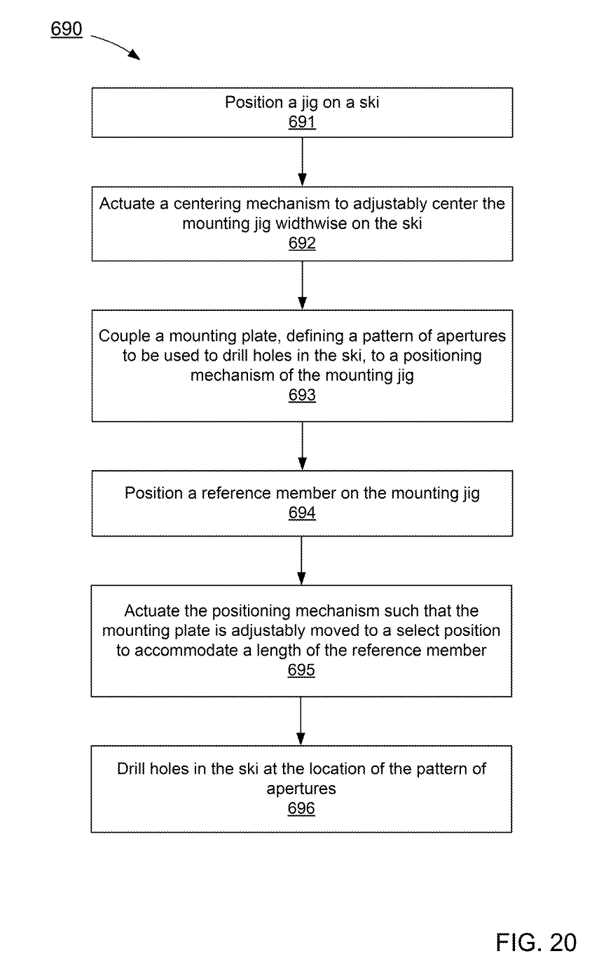

FIG. 20 is a flowchart illustrating a method 690 of using a mounting jig (e.g., 100, 200), according to an embodiment. The method 690 includes positioning the mounting jig (also referred to herein as “jig”) on a ski, at 691. In some instances, the jig can be placed in a desired location relative to the ski. For example, as described above with reference to the jig 200, indicia or the like on the jig can be aligned with indicia disposed (e.g. printed, engraved, embossed, etc.) on the ski. A centering mechanism can be actuated to adjustably center the jig widthwise on the ski, at 692. For example, a jig can include a centering mechanism such as the centering mechanisms (130, 230) described herein. In this manner, an actuator of the centering mechanism can be manipulated to move one or more clamp members to engage, for example, opposite sides of the ski. For example, as described above with reference to the centering mechanism 230, the actuator 250 can be actuated to place the engagement portions 238 and 248 in contact with a first side of a ski and a second side of a ski, opposite the first side, respectively. In this manner, the centering mechanism can both center the jig relative to the width of the ski and couple the jig to the ski.

At 693, a mounting plate defining a pattern of apertures to be used to drill holes in the ski can be coupled to a positioning mechanism (e.g., 160, 260) of the mounting jig. The mounting plate can be various suitable shapes, size, or configuration. In some embodiments, the mounting plate can be a single mounting plate (e.g., 561). In other embodiments, the mounting plate can include a first portion or member (e.g., 161, 261, 361, 461) and a second portion or member (e.g., 166, 266, 366, 466) that can be configured to move relative to one another. In still other embodiments, more than two mounting plates or portions can be coupled to the positioning mechanism. Thus, as described above with reference to the positioning mechanism 260, the jig can be used with multiple different mounting plates that can be removably coupled to the positioning mechanism. For example, a first mounting plate or set of mounting plates can define a pattern of apertures associated with a first a ski binding having a first unique pattern of mounting holes can be removably coupled to the positioning mechanism and used with the jig to facilitate the drilling of holes in a ski. The jig can also be used with a second mounting plate or set of mounting plates that define a pattern of apertures associated with a second ski binding. For example, the first mounting plate or set of mounting plates can be removed from the jig and the second mounting plate or set of mounting plates can be removably coupled to the positioning mechanism of the jig.

A reference member can be positioned on the mounting jig, at 694. For example, the reference member can be a ski boot that can be placed in contact with a portion of at least one mounting plate. The reference member can alternatively be, for example, an object having a predetermined length that can be used to position the positioning mechanism lengthwise relative to the ski. Such an object may be used to position the jig to drill holes associated with, for example, a demo binding. At 695, the positioning mechanism can be actuated such that the mounting plate is adjustably moved to a select position to accommodate a length of the reference member. For example, in some embodiments, the positioning mechanism can include a retention member that can be moved from a first configuration in which the retention member maintains the mounting plate in a relatively fixed position relative to the jig and a second configuration in which the retention member allows the mounting plate to be moved relative to the jig. In some embodiments, the positioning mechanism can be substantially similar to or the same as the positioning mechanism 260 included in the jig 200. In such embodiments, the positioning mechanism can be moved such that a first mounting plate and a second mounting plate are moved relative to one another to accommodate, for example, the length of a ski boot. In other embodiments, a positioning mechanism that is substantially similar to or the same as the positioning mechanism 260 can be used to move a single mounting plate to accommodate a length of any suitable reference member.

At 696, holes can be drilled in the ski at the location of the pattern of apertures. For example, with the mounting plate(s) in a desired position, a drill bit can be advanced through each aperture from the pattern of apertures defined by the mounting plate(s) to allow a user to drill holes in a desired position relative to the ski. In this manner, the drilled holes can be used to position one or more ski bindings in a desire location along a length and a width of any suitable ski.

Although the jig 200 was described above with reference to use with a pair of mounting plates 261 and 266, it should be understood that the jig 200 can be used with other mounting plates having a different pattern of apertures to facilitate the mounting of various types and styles of bindings to a ski. In other embodiments, the jig 200 can be used with more than two mounting plates. For example, in some embodiments, multiple mounting plates can define the apertures for a particular ski binding and the jig can be configured to move the mounting plates in a similar manner as described above for jig 100 and jig 200.

Although the positioning mechanisms 160 and/or 260 are shown and described above as centering a ski boot relative to the jig 100 and/or 200, respectively, and determining the desired position of the ski bindings based on the desired boot placement, in other embodiments, the positioning mechanism 160 and/or 260 can be manipulated to move a set of mounting plates or the like to a desired position along the length of the ski that need not be based on the position of a specific boot. For example, in some instances, the positioning mechanism 160 and/or 260 can be manipulated to define a desired distance between a point on a mounting plate (e.g., a guide opening) and the center of the jig 100 and/or 200, respectively. Thus, the jig can facilitate the placement of ski bindings without centering, aligning, and/or otherwise using a ski boot.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

Where schematics and/or embodiments described above indicate certain components arranged in certain orientations or positions, the arrangement of components may be modified. Similarly, where methods and/or events described above indicate certain events and/or procedures occurring in certain order, the ordering of certain events and/or procedures may be modified. While the embodiments have been particularly shown and described, it will be understood that various changes in form and details may be made.

Although various embodiments have been described as having particular features and/or combinations of components, other embodiments are possible having a combination or sub-combination of any features and/or components from any of the embodiments discussed above.

What is claimed:

1. An apparatus, comprising:
a frame;
a centering mechanism coupled to the frame and configured to adjustably center the apparatus widthwise on a ski;
a positioning mechanism coupled to the frame; and
a mounting plate configured to be removably coupled to the positioning mechanism, the mounting plate including a unique pattern of apertures configured to provide a guide for drilling holes in the ski,
the positioning mechanism configured to adjustably move the mounting plate in a lengthwise direction relative to the ski to a position to accommodate a length of a select reference member.

2. The apparatus of claim 1, wherein the mounting plate is a first mounting plate, the pattern of apertures is a first pattern, the apparatus further comprising:
a second mounting plate configured to be removably coupled to the positioning mechanism, the second mounting plate including a second pattern of apertures, the first pattern of apertures and the second pattern of apertures collectively configured to provide a guide for drilling holes in the ski.

3. The apparatus of claim 1, wherein the centering mechanism includes a first clamp arm, a second clamp arm, and a lever configured to actuate the first clamp arm and the second arm simultaneously such that the first clamp arm engages a first lateral side of the ski and the second clamp arm engages a second lateral side of the ski on an opposite side of the ski than the first lateral side.

4. The apparatus of claim 2, wherein the positioning mechanism includes an actuator configured to simultaneously move the first mounting plate in a first direction and the second mounting plate in a second opposite direction until a distance between a first stop member on the first mounting plate and a second stop member on the second mounting plate corresponds to the length of the select reference member.

5. The apparatus of claim 1, wherein the positioning mechanism includes a lock member configured to at least one of limit or prevent the positioning mechanism from moving relative to the ski and to maintain the position of the mounting plate.

6. The apparatus of claim 1, wherein the centering mechanism includes a lock member configured to at least one of limit or prevent the centering mechanism from moving relative to the ski.

7. The apparatus of claim 1, wherein the centering mechanism includes a first clamp mechanism coupled to the frame on a first end portion of the frame and a second clamp mechanism coupled to the frame on a second end portion of the frame, the first clamp mechanism includes first clamp arm and a second clamp arm, the first clamp arm and the second arm configured to be simultaneously moved such that the first clamp arm engages a first lateral side of the ski and the second clamp arm engages a second lateral side of the ski on an opposite side of the ski than the first lateral side,
the second clamp mechanism includes third clamp arm and a fourth clamp arm, the third clamp arm and the fourth clamp arm configured to be simultaneously moved such that the third clamp arm engages the first lateral side of the ski and the second clamp arm engages the second lateral side of the ski.

8. The apparatus of claim 1, wherein the reference member is a ski boot.

9. An apparatus, comprising:
a mounting plate configured to be selectively and removably coupled to a mounting jig for use in drilling a plurality of holes in a ski to be used to mount a ski binding to the ski
the mounting plate defining a select pattern of apertures associated with a select ski binding, the apertures configured to be used to guide the drilling of the plurality of holes in a ski.

10. The apparatus of claim 9, wherein the mounting plate includes a first mounting plate and a second mounting plate that collectively define the select pattern of apertures.

11. The apparatus of claim 9, wherein the first mounting plate defines a first plurality of apertures and is associated with a first portion of the pattern of apertures associated with the select ski binding for drilling holes to mount a toe portion of the ski binding, the second mounting plate defines a second plurality of apertures and is associated with a second portion of the pattern of apertures associated with the select ski binding for drilling holes to mount a heel portion of the ski binding.

12. The apparatus of claim 10, wherein the first mounting plate includes a first stop member, the second mounting plate includes a second stop member, the first stop member configured to engage a first end of a reference member and the second stop member configured to engage a second end of the reference member when the first mounting plate and the second mounting plate are each coupled to a mounting jig and the reference member is disposed on the mounting jig to adjust the mounting jig to correspond to a length of the reference member.

13. The apparatus of claim 10, when mounted to a mounting jig, the first mounting plate and the second mounting plate are configured to be simultaneously moved such that the first mounting plate is moved in a first direction and the second mounting plate is moved in a second opposite direction until a distance between a first stop member on the first mounting plate and a second stop member on the second mounting plate corresponds to a select length of a reference member.

14. The apparatus of claim 9, wherein the mounting plate includes a stop member configured to engage an end portion of a reference member when the mounting plate is coupled to the mounting jig and the reference member is disposed on the mounting jig to adjust the mounting jig to correspond to a length of the reference member.

15. A method, comprising:
positioning a mounting jig on a ski;
actuating a centering mechanism to adjustably center the mounting jig widthwise on the ski;
coupling a mounting plate to a positioning mechanism of the mounting jig, the mounting plate defining a pattern of apertures to be used to drill holes in the ski, the pattern of apertures associated with a ski binding;
positioning a reference member on the mounting jig;
actuating the positioning mechanism such that the mounting plate is adjustably moved to a select position to accommodate a length of the reference member; and
drilling holes in the ski at the location of the pattern of apertures.

16. The method of claim 15, after the positioning the reference member, locking the positioning mechanism such that the positioning mechanism is prevented from moving and the mounting plate is maintained at the select position.

17. The method of claim 15, further comprising:
removing the mounting plate from the positioning mechanism; and
coupling a second mounting plate to the positioning mechanism, the second mounting plate defining a second pattern of apertures to be used to drill holes in the ski.

18. The method of claim 15, wherein the reference member is a first reference member, the method further comprising:
unlocking the positioning mechanism;
removing the mounting plate from the positioning mechanism;
coupling a second mounting plate to the positioning mechanism, the second mounting plate defining a second pattern of apertures to be used to drill holes in the ski, the second pattern of apertures associated with a second ski binding different than the first ski binding; and
actuating the positioning mechanism such that the second mounting plate is adjustably moved to a select position to accommodate a length of a second reference member.

19. The method of claim 15, wherein the positioning includes aligning a mark on the mounting jig to a line on the ski to position the mounting jig lengthwise on the ski.

20. The method of claim 15, further comprising:
prior to the actuating the positioning mechanism, removing the reference member from the mounting jig.
